(19) United States
(12) Patent Application Publication
(10) Pub. No.: US 2013/0119079 A1
(43) Pub. Date: May 16, 2013

(54) CLOSURE

(71) Applicants: David Ziegenhorn, Grayslake, IL (US); Jay Hinkle, Bartlett, IL (US); Greg Showers, Spring Grove, IL (US); Kerry D. Azelton, Pleasanton, CA (US); Stacie M. Alvarez, Pleasanton, CA (US)

(72) Inventors: David Ziegenhorn, Grayslake, IL (US); Jay Hinkle, Bartlett, IL (US); Greg Showers, Spring Grove, IL (US); Kerry D. Azelton, Pleasanton, CA (US); Stacie M. Alvarez, Pleasanton, CA (US)

(73) Assignee: The Clorox Company, Oakland, CA (US)

(21) Appl. No.: 13/467,961

(22) Filed: May 9, 2012

(30) Foreign Application Priority Data
May 10, 2011 (GB) 1107758.3
May 10, 2011 (GB) 1107760.9

(51) Int. Cl. B65F 1/16

(52) U.S. Cl. CPC B65F 1/16
USPC 220/810

(57) ABSTRACT

In various embodiments, a closure may include a base attachable to a container. The closure may further include an engagement insert receivable in the base. The engagement insert may include screw thread formations for engaging corresponding formations on a container neck. The base and insert may together form a co-operating uni-directional rotation arrangement which prevents rotation in a direction of screwing onto a container neck but allows relative rotation in a direction of unscrewing, whereby to prevent unscrewing of the closure. In various embodiments, a closure for a container may include a top deck, an outer skirt and an inner skirt. The inner skirt may be engagable with a container neck. The inner skirt and/or top deck may comprise one or more regions of weakness arranged to break and/or deform if an attempt is made to remove the closure from a neck following first application, whereby to prevent re-application.

### CROSS REFERENCE TO RELATED APPLICATIONS

This application claims benefit under 35. U.S.C. §119 to United Kingdom Patent Application Nos. 1107760.9 and 1107758.3, both filed May 10, 2011, and both of which are incorporated herein by reference for all purposes.

### BACKGROUND

It is well known to provide mechanisms for indicating if a closure has been opened at least once, for example tamper evident bands and tabs. However, there are situations in which what is of more concern is ensuring that the closure has not been completely removed so that an associated container can be filled, for example with an inferior product.

### SUMMARY

According to a first aspect of the present invention there is provided a closure comprising a base attachable to a container, the closure comprising an engagement insert receivable in the base and including screwthread formations for engaging corresponding formations on a container neck. The base and insert comprising a cooperating uni-directional rotation arrangement which prevents rotation in a direction of screwing onto a container but allows relative rotation in a direction of unscrewing, whereby to prevent unscrewing of the closure.

The insert therefore provides the base with an anti-removal system which allows the closure to be screwed on to a container neck but which prevents unscrewing.

The axial position of the insert within the base may be fixed. For example, the insert may be clipped into the closure base so that relative rotation between the insert and base is possible but substantially no relative axial movement is possible.

The insert may be snap fitted into the base. The insert and base may therefore be provided with cooperating snap fit engagement means, such as snap beads, flanges and the like, to facilitate attachment of the insert into the base.

The base may comprise an outer skirt and an inner skirt and the insert may be received by the inner skirt, for example within it. The closure may further comprise a lid, which may be hingedly connected to the base for example by a snap hinge or the like.

The closure may be formed as a dispensing closure and therefore may further comprise a dispensing orifice or structure such as a dispensing spout. A self closing valve may be provided to regulate the flow of product from a container through a dispensing orifice.

According to a further aspect of the present invention there is provided a closure comprising a base attachable to a container, the base comprising a top deck from which depends and outer and an inner skirt, the inner skirt being attachable to a container, in which the top deck includes a region of weakness between the inner and outer skirts which is deformed and/or broken if removal of the closure from a container following attachment is attempted.

By providing a region of weakness in the top deck, if removal of the closure is attempted an irreversible change in the structure of the top deck results so that the closure cannot be reapplied to a container neck.

The region of weakness on the top deck may comprise a line of weakness which may, for example, be in the form of a material thinning.

The region of weakness may be generally annular and may, for example, be parallel to the inner and outer skirts.

According to a further aspect of the present invention there is provided a closure for a container, the closure having an outer skirt and an inner skirt, the inner skirt being engagable with a container neck and comprising one or more regions of weakness arranged to break and/or deform if an attempt is made to remove the closure from the neck following first application, whereby to prevent reapplication.

Therefore if the closure is removed to allow refilling of the container, the closure cannot be reapplied to the container neck because of a permanent and irreversible change to the inner skirt.

One or more aspects of the present invention may be present in the same closure.

According to a further aspect of the present invention there is provided a closure as described herein in combination with a container.

### BRIEF DESCRIPTION OF THE DRAWINGS

The present invention will now be more particularly described, by way of example, with reference to the accompanying drawings, in which:

FIG. 1 is a perspective view of a closure formed according to the present invention;

FIG. 2 is a front view of the closure of FIG. 1;

FIG. 3 is a plan view of the closure of FIG. 1 shown in open, as-moulded condition;

FIG. 4 is a section of the closure of FIG. 3 taken along line A-A;

FIG. 5 is a rear perspective view of the closure of FIG. 3;

FIG. 6 is a front perspective view of the closure of FIG. 3;

FIG. 7 is an underplan perspective view of the base of the closure of FIGS. 1 to 6;

FIG. 8 is a magnified view of an inner skirt region of the base of FIG. 7;

FIG. 9 is an underplan perspective view of a base formed according to an alternative embodiment and shown with an insert removed;

FIG. 10 is an underplan view of the base of FIG. 9;

FIG. 11 is a further underplan perspective view of the base of FIG. 9;

FIG. 12 is a section of the base of FIGS. 9 to 11;

FIG. 13 is a perspective sectional view of the base of FIG. 12;

FIG. 14 is a further sectional perspective view of the base of FIG. 12;

FIG. 15 is a perspective view of an engagement insert suitable for use with the base of FIGS. 7 and 8 or FIGS. 9 to 14;

FIG. 16 is a further perspective view of the insert of FIG. 15;

FIG. 17 is a further perspective view of the insert of FIG. 15;

FIG. 18 is a plan view of the insert of FIGS. 15 to 17;

FIG. 19 is a further plan view of the insert of FIGS. 15 to 17;

FIG. 20 is a section of the insert of FIG. 18 taken along line A-A; and

FIG. 21 is an underplan view of the insert of FIGS. 15 to 20.

### DETAILED DESCRIPTION

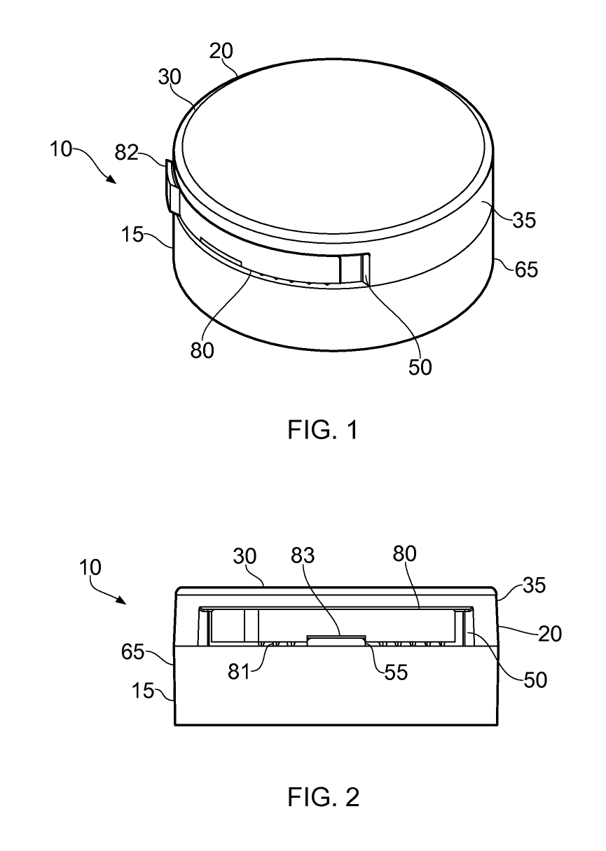

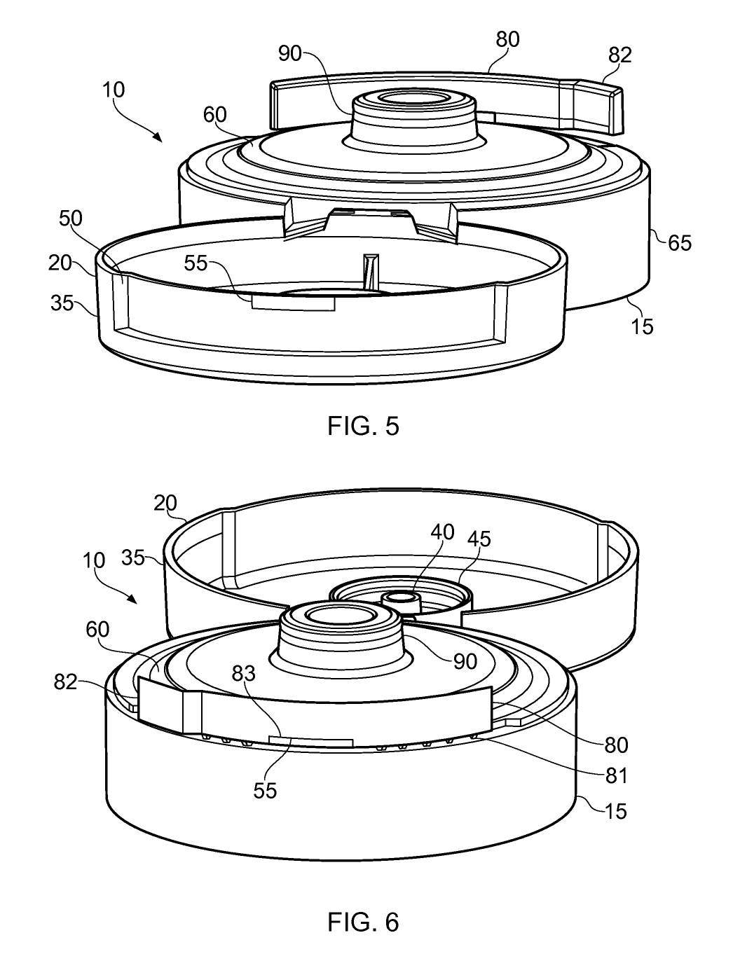

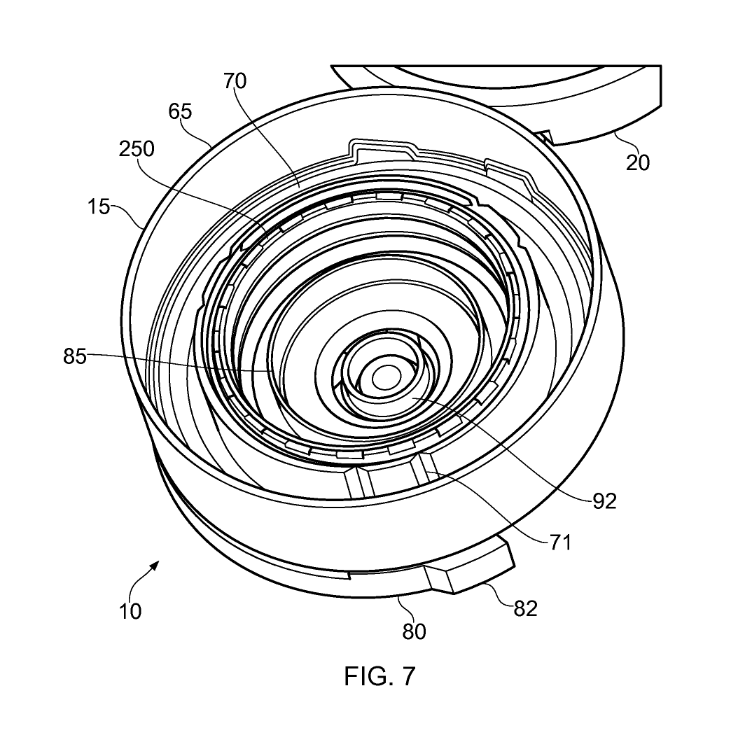

Referring first to FIGS. 1 to 6 there is shown a closure generally indicated 10. The closure 10 comprises a generally cylindrical body with a base 15 and a lid 20. The base 15 and lid 20 are connected to each other by a hinge 25.

The lid 20 comprises a circular, disc-shape top plate 30 and a generally cylindrical side wall 35 which depends from the periphery of the plate 30. An annular spigot 40 depends from the centre of the plate and an annular sealing projection 45 also depends from the top plate radially outwardly of the spigot 40.

Opposite the hinge the lid side wall 35 includes an arcuate recess 50 an at the centre of the recess 50 a hook 55 projects from the open end of the skirt 35.

The base 15 comprises a generally circular-disc shape top deck 60 which is gently convexly curved. A generally cylindrical outer skirt 65 depends from the periphery of the deck 60. A further, cylindrical inner skirt 70 depends from the deck 60 radially inwardly of the outer skirt 65. At the open end of the skirt 70 a discontinuous annular snap bead 75 is positioned.

A sealing spigot 85 depends from the deck radially inwardly of the skirt 70.

At the centre of the deck 60 an annular spout 90 projects and defines a central dispensing orifice 91. Within the spout 90 a self-closing valve 92 is carried (see FIG. 7).

Opposite the hinge 25 an arcuate tamper-evident band 80 upstands from the deck 60 and is connected thereto by a plurality of frangible bridges 81. At one end of the band 80 is a pull tab 82 which is not directly connected to the platform 60. At the centre of the band a notch 83 is provided.

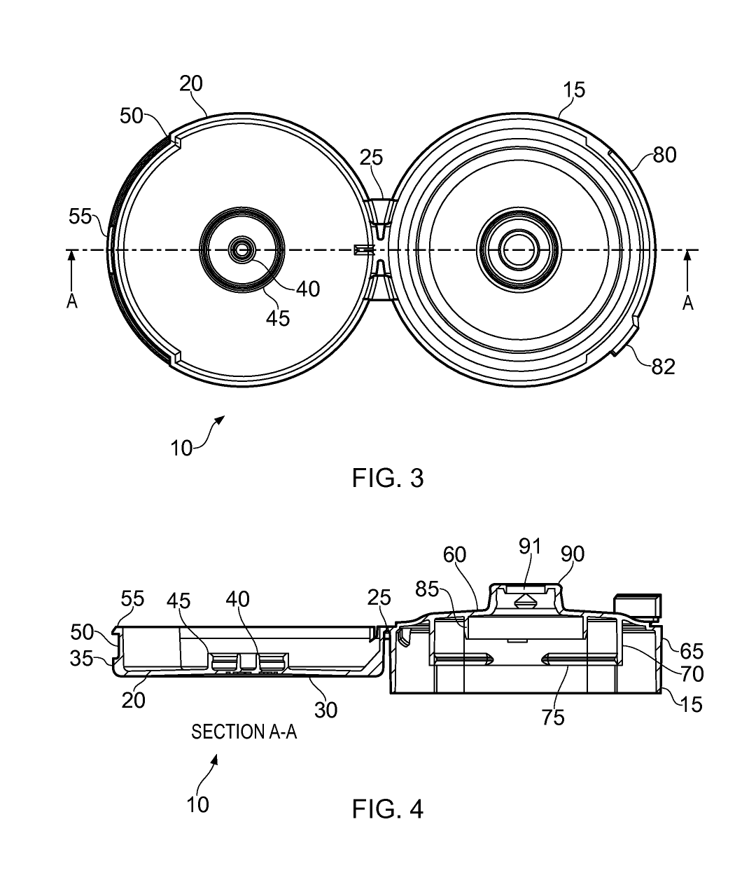

In FIGS. 3 to 6 the closure is shown in an as-moulded condition. Following moulding the lid 20 is folded over onto the base. In doing so, the spigot 40 is pushed into the orifice 95, the projection 45 fits around the spout 90 and the hook 55 passes behind the band 80 and snaps into the notch 83.

In use the lid cannot be lifted away from the base until the band 80 has been removed. To remove the band 80 the tab 82 is grasped and pull across the front of the closure, in doing so breaking the bridges 81 and allowing removal. Thereafter the lid 20 can be hinged away from the base 15 to expose the spout 90 so that product can be dispensed through the opening 91 via the valve 92.

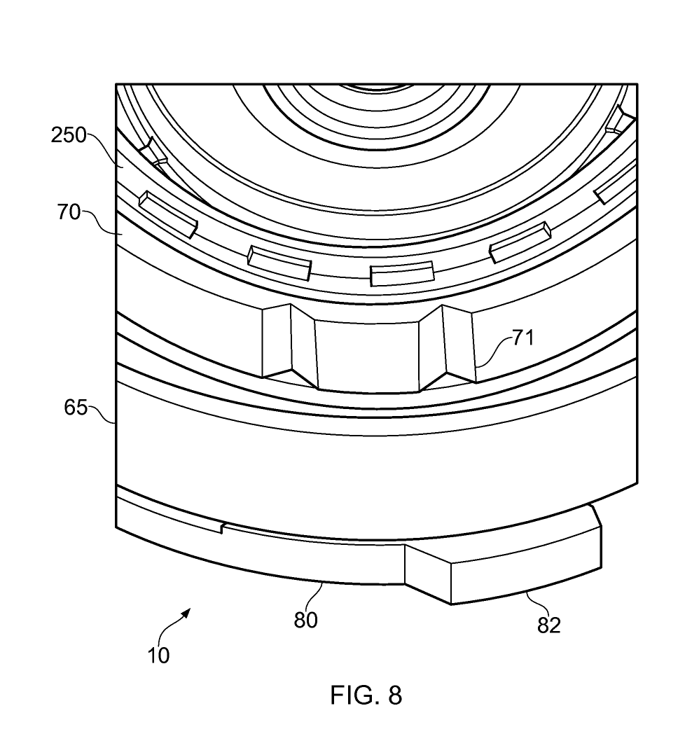

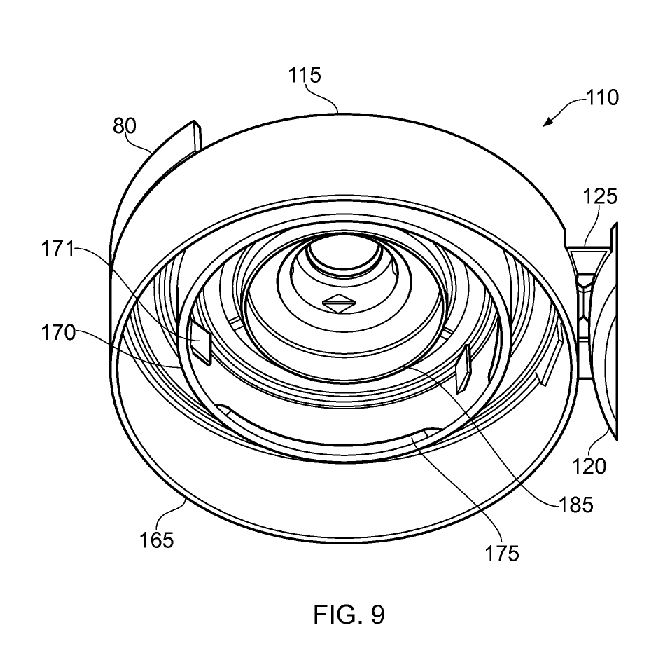

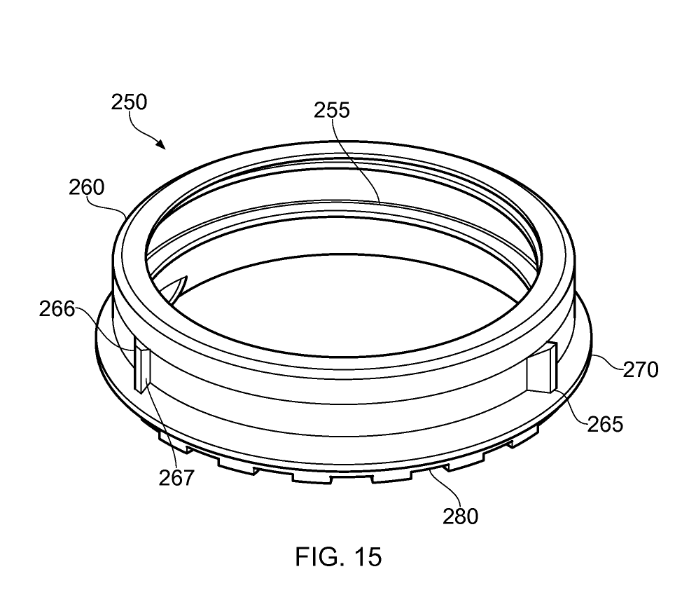

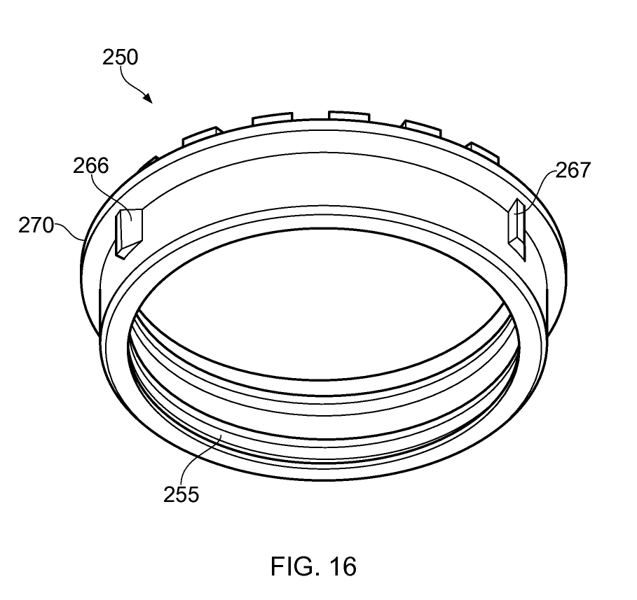

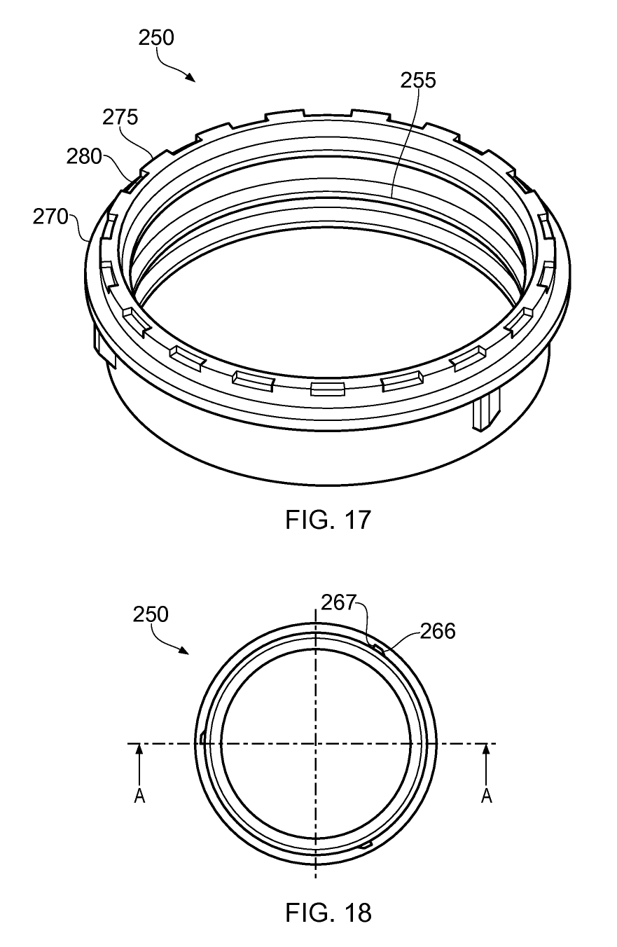

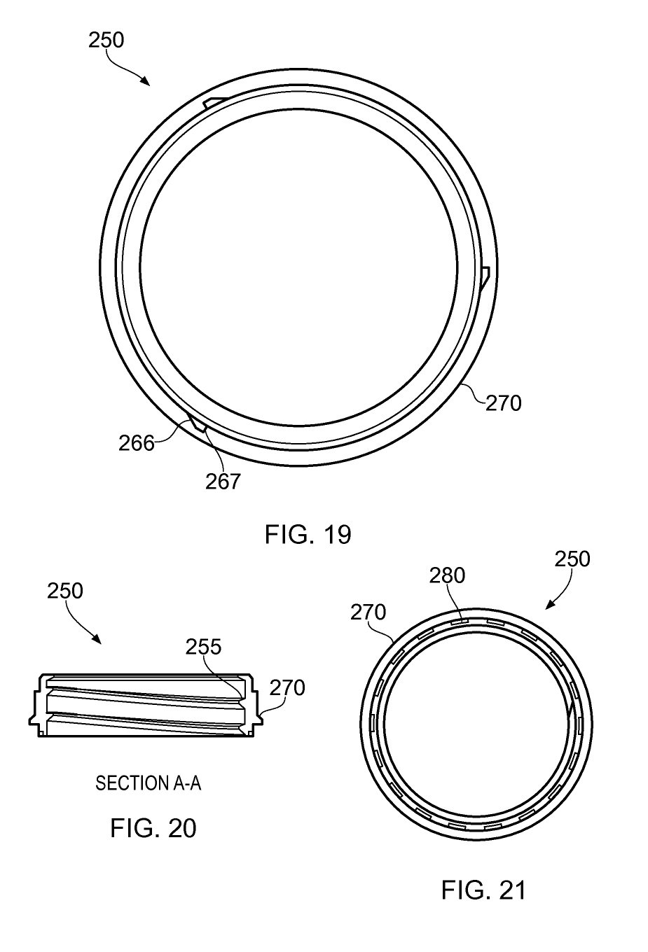

In FIGS. 7 and 8 the underside of the base 15 is shown. The inner skirt 70 carries within it an engagement insert 150 which is shown in more detail in FIGS. 15 to 21. The inner skirt 70 includes a plurality of axial notches 71 which define lines of weakness that break if removal of the closure from a neck is attempted.

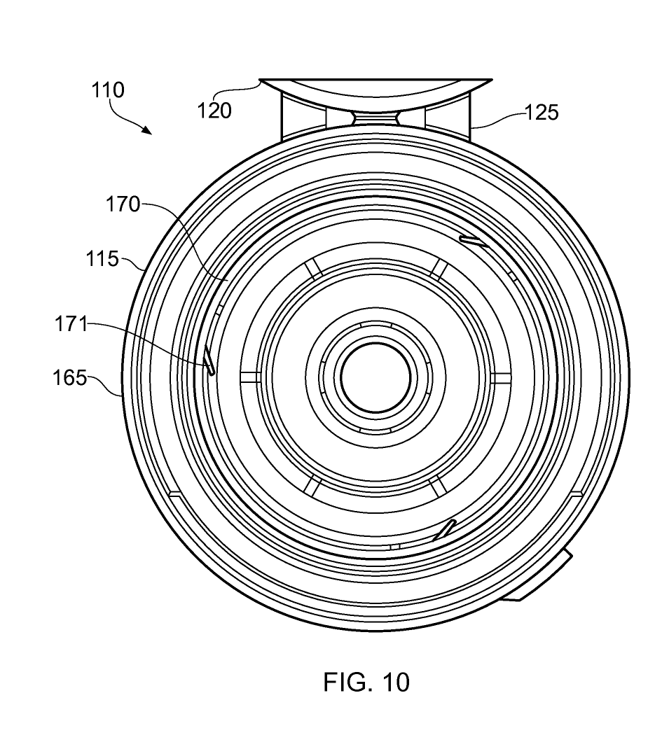

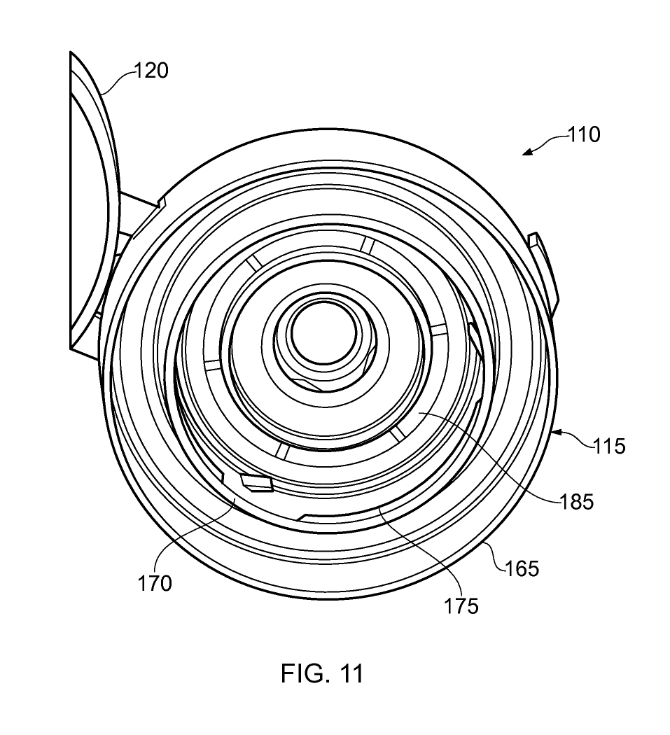

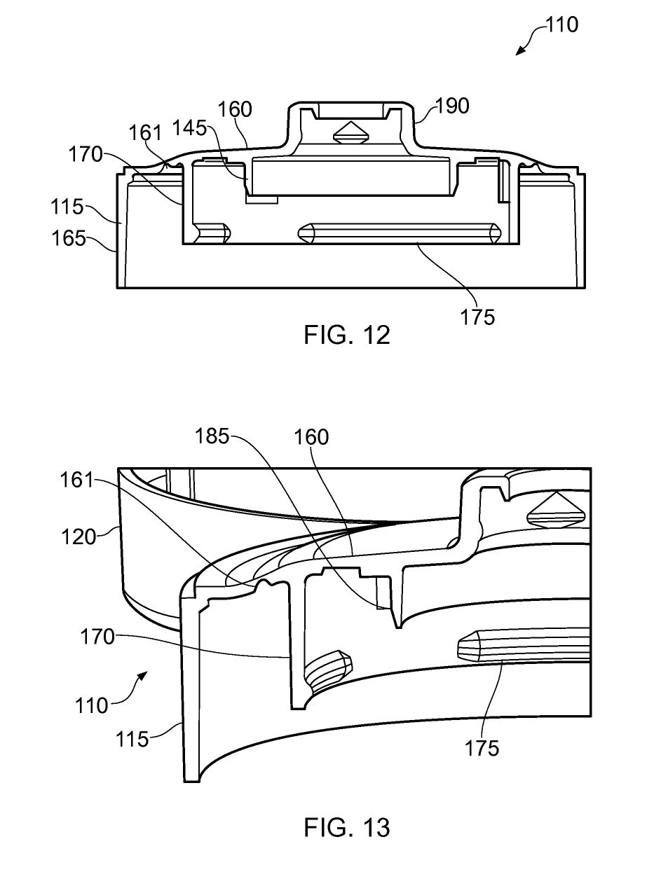

The insert 150 is suitable for use with the base shown in FIGS. 7 and 8 or the alternative base structure shown in FIGS. 9 to 13.

Referring now to FIGS. 15 to 21 the insert 250 is shown in more detail. The insert 250 comprises a generally annular, collar-like body on the inside of which is provided a screwthread formation 255 for engaging a corresponding screwthread formation (not shown) on an associated container neck.

The insert 250 comprises a top, engagement portion 260. Around the periphery of the portion 260 are positioned three wedge-like teeth 265 each comprising an inclined face 266 and a flat abutment face 267.

A flange 270 projects radially outwardly from the portion 260. On the other side of the flange 270 a second portion 275 extends and carries a plurality of notches 280.

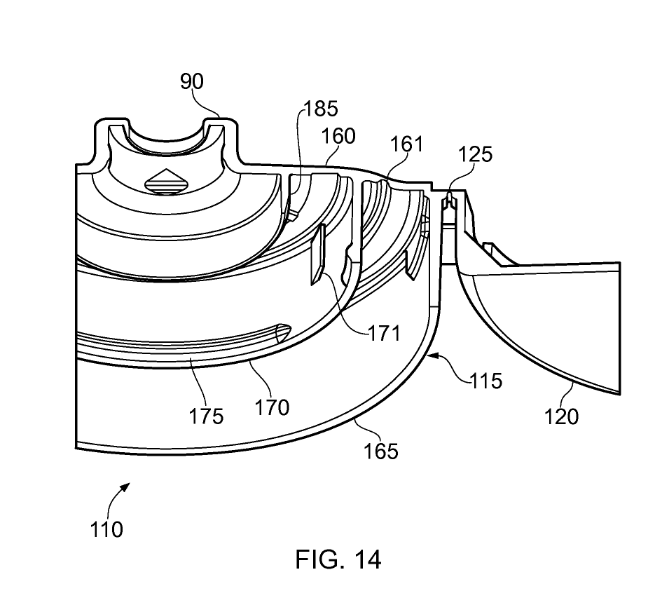

Referring now to FIGS. 9 to 14 a base 115 formed according to an alternative embodiment is shown. The base 115 is very similar to the base 15 shown in FIGS. 1 to 8 except there is no weakening of the inner skirt provided by notches. With the insert 250 removed it will be seen that the inner face of the inner skirt 170 carries three inclined lugs 171 which project radially inwardly.

In this embodiment it will be seen that between the inner 170 and outer 165 skirts the top deck 160 includes an annular notch 161 which provides a material thinning. This feature is present to cause defamation and/or breakage of the top deck 160 if an attempt is made to remove the closure following application to a container neck.

In use, an insert 250 of the type described in relation to FIGS. 15 to 21 is inserted into a closure 10, 110 of the type described in relation to FIGS. 1 to 14. The insert 250 is received with the first portion 160 orientated towards the top deck 60, 160 and is push fitted so that the flange 170 engages under the snap bead 75, 175 so that the insert is firmly retained. With the insert in place the closure can be screwed onto a container neck. When the closure is applied to a container neck and rotated the base 15, 115 will rotate relative to the insert until the base lugs 171 contact respective abutment faces 167 of the insert teeth 165. At this point continued rotation of the base will cause the insert, and hence the closure, to be screwed onto the container neck. Thereafter, if unscrewing of the closure is attempted the base 15, 115 will rotate relative to the insert 250 and the lugs 171 will pass over, but not engage the inclined faces 166 of the teeth. In other words relative rotation between the base and the insert is permitted in the direction of unscrewing of the insert so that unscrewing cannot occur.

If an attempt is made to pull or lever the closure off a container neck because it cannot be unscrewed, either or both of the regions of weakening described in relation to FIGS. 7 and 8 and 11 to 14 may be used to deliberately damage the closure so that it cannot be reapplied.

What is claimed is:

1. A closure comprising a base attachable to a container, the closure comprising an engagement insert receivable in the base and including screw thread formations for engaging corresponding formations on a container neck, the base and insert comprising a co-operating uni-directional rotation arrangement which prevents rotation in a direction of screwing onto a container neck but allows relative rotation in a direction of unscrewing, whereby to prevent unscrewing of the closure.

2. The closure of claim 1, wherein the axial position of the insert within the base is fixed.

3. The closure of claim 1, wherein the insert is snap fitted into the base.

4. The closure of claim 1, wherein the base comprises an outer skirt and an inner skirt.

5. The closure of claim 4, wherein the insert is received by the inner skirt.

6. The closure of claim 5, wherein the closure further comprises a lid.

7. The closure of claim 1, further comprising a dispensing spout.

8. The closure of claim 1, further comprising a self-closing valve.

9. A closure comprising a base attachable to a container, the base comprising a top deck from which depends an outer and an inner skirt, the inner skirt being attachable to a container, wherein the top deck includes a region of weakness between the inner and outer skirts which is deformed and/or broken if removal of the closure from a container following attachment is attempted.

10. The closure of claim 9, wherein the region of weakness comprises a line of weakness.

11. The closure of claim 10, wherein the region of weakness comprises a material thinning.

12. The closure of claim 11, wherein the region of weakness is generally annular.

13. A closure for a container, the closure having an outer skirt and an inner skirt, the inner skirt being engagable with a container neck and comprising one or more regions of weakness arranged to break and/or deform if an attempt is made to remove the closure from a neck following first application, whereby to prevent re-application.
